(19) United States
(12) Patent Application Publication
(10) Pub. No.: US 2022/0013302 A1
(43) Pub. Date: Jan. 13, 2022

(54) SOLID ELECTROLYTIC CAPACITOR

(71) Applicant: SAMSUNG ELECTRO-MECHANICS CO., LTD., Suwon-si (KR)

(72) Inventors: Youn Soo KIM, Suwon-si (KR); Hyun Sub OH, Suwon-si (KR); Hee Sung CHOI, Suwon-si (KR); Hong Kyu SHIN, Suwon-si (KR); Jin Ho HONG, Suwon-si (KR); Yong Sam LEE, Suwon-si (KR); Jung Youn KIM, Suwon-si (KR); Ran Suk YANG, Suwon-si (KR)

(21) Appl. No.: 17/095,104

(22) Filed: Nov. 11, 2020

(30) Foreign Application Priority Data
Jul. 10, 2020 (KR) 10-2020-0085553

(51) Int. Cl. H01G 9/15; H01G 9/048; H01G 9/042

(52) U.S. Cl. CPC H01G 9/15; H01G 2009/05; H01G 9/042; H01G 9/048

(57) ABSTRACT

The present disclosure relates to a solid electrolytic capacitor, including a body comprising a tantalum wire disposed on one end thereof; a substrate, on which the body is disposed, comprising an insulating layer, first and second wiring layers respectively disposed on a first surface and a second surface, facing each other, of the insulating layer, and a via electrode penetrating the insulating layer to connect the first and second wiring layers to each other; and a connection portion connecting the tantalum wire to the first wiring layer.

### CROSS-REFERENCE TO RELATED APPLICATION

The present application claims the benefit of priority to Korean Patent Application No. 10-2020-0085553, filed on Jul. 10, 2020 in the Korean Intellectual Property Office, the disclosure of which is incorporated herein by reference in its entirety.

### TECHNICAL FIELD

The present disclosure relates to a solid electrolytic capacitor, and more particularly, to a solid electrolytic capacitor having excellent equivalent series resistance (ESR) properties, and improved capacitance and adhesion properties.

### BACKGROUND

A solid electrolytic capacitor is an electronic component used to block a direct current and allow an alternating current to pass therethrough as well as to accumulate electricity. A tantalum capacitor, among all types of solid electrolytic capacitors described above, is representatively being manufactured.

Tantalum (Ta) is a metal widely used in various industrial sectors, such as the aerospace and defense industries, in addition to the electrical, electronic, mechanical, and chemical fields, due to excellent mechanical and physical properties such as a high melting point, excellent flexibility and corrosion-resistance, and the like.

Tantalum can form a stable anodic oxide film and has thus been widely used as a material for anodes of small capacitors. Recently, in accordance with rapid development of information technology (IT), information and communications technology (ICT) and electronics technology, use of tantalum has been increasing every year.

A capacitor is a component in which two plate electrodes, insulated from each other, are closely spaced with each other, separated by a dielectric, and electric charges build up on each plate electrode, and is used to obtain capacitance by storing electrical charges between the two conductors.

A tantalum capacitor using the tantalum material has a structure which uses voids generated when a tantalum powder is sintered. Oxidized tantalum (Ta₂O₅) is formed on a surface of tantalum by anode oxidization, and a manganese dioxide (MnO₂) layer is formed as an electrolyte on the oxidized tantalum which serves as a dielectric. A carbon layer and a metal layer are formed on the manganese dioxide layer to form a main body. An anode and a cathode are formed in the main body, and a molding portion is then formed for mounting on a printed circuit board (PCB).

The tantalum capacitor is not only applied to general industrial machinery but also to an application circuit used in a low rated voltage range. In particular, the tantalum capacitor is used to reduce a noise of a circuit or a portable communications apparatus in which frequency characteristics may be problematic.

A conventional tantalum capacitor employs a structure in which an internal lead frame is formed or a terminal is externally extracted without a frame so as to connect a tantalum material to an electrode.

In the case of the structure employing an internal lead frame, a space occupied by the tantalum material in a molding part may be reduced by the lead frame forming an anode and a cathode. Further, as capacitance is proportional to a volume of the tantalum material, a problem of limited capacitance may arise.

Meanwhile, in the case of the structure in which a terminal is outwardly extracted without a frame, there is a limitation on capacitance improvement due to reduced internal volume of the tantalum material for reasons such as a need to secure a welding distance in which a solder is formed to couple a cathode lead frame disposed on a side surface to the tantalum material. Further, as there are multiple materials which are in contact, contact resistance increases, thereby increasing ESR of the capacitor.

In addition, as an anode wire is directly led-out and connected to an external terminal, a contact area therebetween is reduced, which increases surface resistance, and detachment increases.

### SUMMARY

An aspect of the present disclosure is to a solid electrolytic capacitor having improved capacitance and reduced equivalent series resistance (ESR), as a structure in which an internal lead frame is not formed.

Another aspect of the present disclosure is to provide a solid electrolytic capacitor having an increased mounting surface area by forming a via electrode using a pattern-formed substrate and forming an anode connection portion using a plating method.

According to an aspect of the present disclosure, a solid electrolytic capacitor includes a body comprising a tantalum wire disposed on one end thereof; a substrate, on which the body is disposed, comprising an insulating layer, first and second wiring layers respectively disposed on a first surface and a second surface, facing each other, of the insulating layer, and a via electrode penetrating the insulating layer to connect the first and second wiring layers to each other; and a connection portion connecting the tantalum wire to the first wiring layer, wherein the first and second wiring layers and the via electrode are integrally formed.

According to another aspect of the present disclosure, a solid electrolytic capacitor includes a body comprising a tantalum wire disposed on one end thereof; a substrate, on which the body is disposed, comprising: an insulating layer; first and second wiring layers disposed on first and second surfaces, opposing each other, of the insulating layer, each of the first and second wiring layers having an anode portion and a cathode portion; first and second via electrodes penetrating the insulating layer to connect the anode portions of the first and second wiring layers to each other and connect the cathode portions of the first and second wiring layers to each other, respectively; and a connection portion connecting the tantalum wire to the anode portion of the first wiring layer.

According to still another aspect of the present disclosure, a solid electrolytic capacitor includes a body comprising a tantalum wire disposed on one end thereof; a substrate, on which the body is disposed, comprising an insulating layer, first and second wiring layers respectively disposed on a first surface and a second surface, facing each other, of the insulating layer, and a via electrode penetrating the insulating layer to connect the first and second wiring layers to each other; and a connection portion connecting the tantalum wire to the first wiring layer. The first and second wiring layers do not extend onto side surfaces of the solid electrolytic capacitor, the side surfaces being defined in the length direction.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view illustrating a schematic structure of a solid electrolytic capacitor according to an exemplary embodiment of the present disclosure;

FIGS. 2A and 2B are cross-sectional views taken along line I-I′ of FIG. 1 according to some exemplary embodiments of the present disclosure; and

FIGS. 3 and 4 are cross-sectional views of a substrate of a solid electrolytic capacitor according to an exemplary embodiment of the present disclosure.

### DETAILED DESCRIPTION

The terms used herein are given to describe only the specific embodiments but not intended to limit the present invention. A singular term includes a plural term unless otherwise stated obviously. As used herein, the terms “include” or “have” are used to indicate that there are features, numerals, steps, operations, components, parts or combinations thereof as described herein, but do not exclude the presence or possibility of addition of one or more features, numerals, steps, operations, components, parts or components thereof. Further, as used herein, the term “on” means positioning on or below the object portion, but does not essentially mean positioning on the upper side of the object portion based on a gravity direction.

When one element is described as being “coupled” to another element, it does not refer to a physical, direct contact between these elements only, but it shall also include the possibility of yet another element being interposed between these elements and each of these elements being in contact with said yet another element.

Sizes and thicknesses of elements as shown in the drawings are randomly indicated for better understanding and ease of description, and thus, the present disclosure is not necessarily limited to the drawings.

In the drawings, the “X direction” may refer to a first direction or a length direction, and the “Y direction” may refer to a second direction or a width direction, while the “Z direction” may refer to a third direction or a thickness direction.

Hereinafter, a solid electrolytic capacitor according to preferred embodiments of the present disclosure will be described with reference to the accompanying drawings. The same or like elements are labeled with the same reference numeral, and any repetitive detailed description thereof will hereinafter be omitted or simplified.

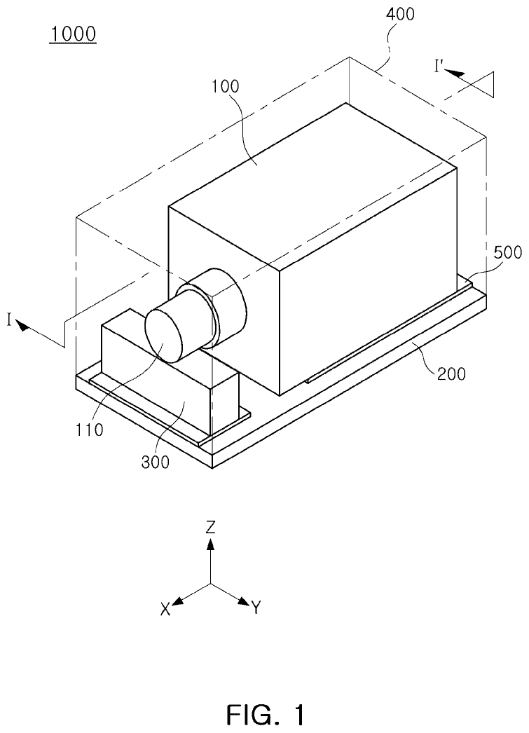

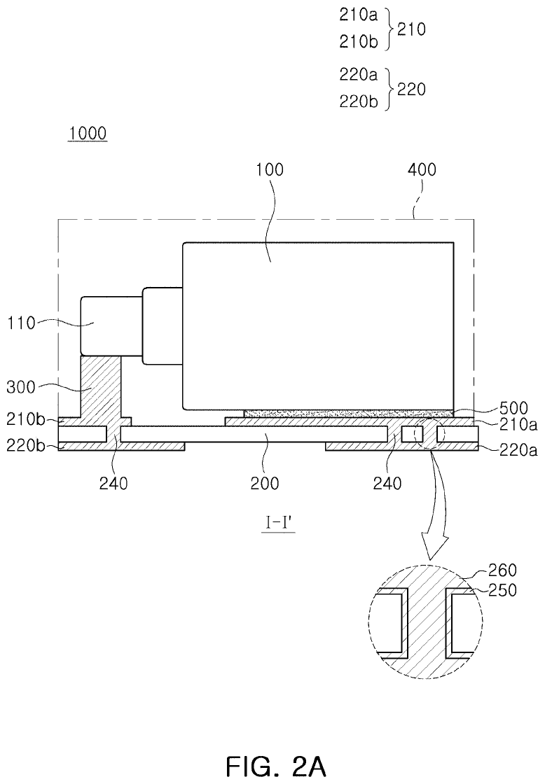

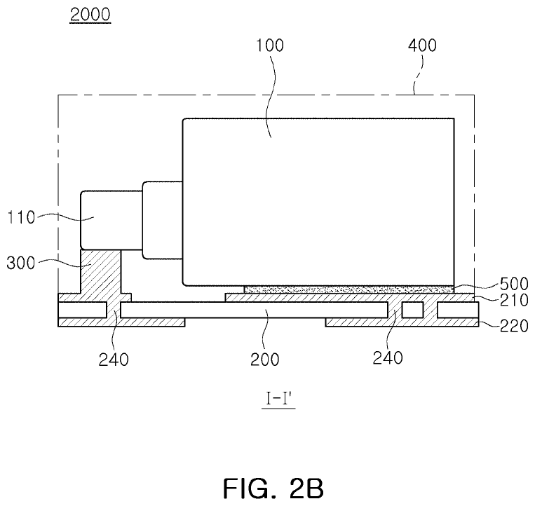

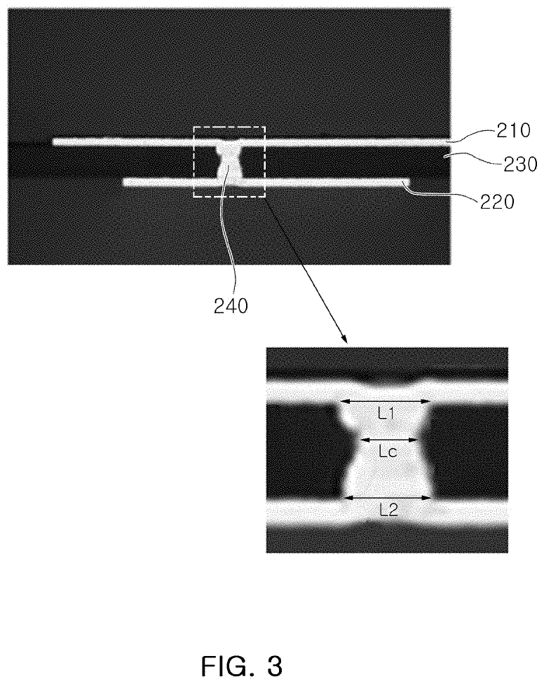

FIG. 1 is a perspective view illustrating a schematic structure of a solid electrolytic capacitor according to an exemplary embodiment of the present disclosure, and FIGS. 2A and 2B are cross-sectional views taken along line I-I′ of FIG. 1 according to some exemplary embodiments of the present disclosure. FIG. 3 is a cross-sectional view of a substrate of a solid electrolytic capacitor according to an exemplary embodiment of the present disclosure.

Referring to FIGS. 1 to 4, a solid electrolytic capacitor 1000 (or 2000) according to an exemplary embodiment may include a body 100, a substrate 200, a connection portion 300, a molding portion 400 and a coupling portion 500. In this exemplary embodiment, a cross-section of the substrate 200 can be calculated by measuring using an optical microscope. For example, magnification of the optical microscope may be set to 200×.

The body 100 may be molded by sintering using a tantalum material. Further, the body 100 may be formed to have a cuboid shape and may include a cathodic tantalum wire 110 formed on one end of the body 100 to be led out.

Such body 100 may be manufactured by, for example, mixing and stirring tantalum powder with a binder at a certain ratio and pressing a mixed powder to forma cuboid shape followed by sintering the same at a high temperature and under high vacuum.

In this case, the tantalum wire 110 may be inserted into a mixture of the tantalum powder and the binder to be eccentrically mounted before pressing the mixed powder.

That is, the body 100 can be manufactured by inserting the tantalum wire 110 into the tantalum powder mixed with the binder to forma tantalum element in a desired size and sintering the tantalum element at about 1000° C. to 2000° C. under high vacuum atmosphere (10⁻⁵ torr or less) for 30 minutes.

The body 100 may have a cathode layer of manganese dioxide (MnO₂) formed on an outer surface thereof, in order to implement negative polarity. Further, a cathode reinforcing layer, on which carbon and silver (Ag) are coated, may be further formed on an outer surface of the cathode layer. In this case, carbon may be provided to reduce contact resistance in the surface of the body 100, and silver (Ag), a material having high electrical conductivity, may be generally used in the art in order to form a conductive layer. However, the present disclosure is not limited thereto.

It is acknowledged that in terms of the drawings and the reference numerals of the cathode layer and the cathode reinforcing layer, the body 100 corresponds to a known technology which can be sufficiently understood by a person skilled in the art without being indicated in the drawings when manufacturing the solid electrolytic capacitor adopted by the present disclosure.

The molding portion 400 may be formed by molding a resin to surround the body 100 and the tantalum wire 110 while having an end of the tantalum wire 110 exposed.

The substrate 200 is formed on a lower surface of the body 100 to electrically connect a negative electrode and a positive electrode.

In the present exemplary embodiment, the insulating layer 230 includes one surface and the other surface facing each other where the one surface of the insulating layer 230 refers to an upper surface and the other surface refers to a lower surface in a thickness direction. The substrate 200 includes the insulating layer 230 and first and second wiring layers 210 and 222 formed on the upper and lower surfaces of the insulating layer 230. The first and second wiring layers 210 and 220 formed on the upper and lower surfaces of the insulating layer 230 may be electrically connected to each other by a via electrode 240 formed to penetrate the insulating layer 230.

Instead of a conventional structure in which an internal lead frame is formed, the body 100 is mounted on the substrate 200 such that an internal volume of the tantalum material increases and capacitance is improved as well as allowing a current to directly flow internally through the via electrode 240 thereby facilitating implementation of relatively lower ESR.

The insulating layer 230 may include f a thermosetting insulating resin such as an epoxy resin, a thermoplastic insulating resin such as polyimide or an insulating material including a photosensitive insulating resin. The insulating layer 230 may include an insulating layer in which a reinforcing material such as a glass fiber or an inorganic filler is impregnated in such an insulating layer. For example, the insulating layer 230 may include prepreg, Ajinomoto build-up film (ABF), FR-4, bismaleimide triazine (BT) resin, photo imageable dielectric (PID), or the like, but is not limited thereto.

As the inorganic filler, one or more selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), boric-acid aluminum (AlBO₃) and calcium zirconate (CaZrO₃).

Meanwhile, the insulating layer 230 is not limited to a copper clad laminate (CCL) having copper bonded to both surfaces thereof and may include a material deposited by a physical vapor deposition (PVD) method in addition to a bonding material. A thickness of the insulating layer 230 may be 30 μm to 50 μm.

The first and second wiring layers 210 and 220 formed on the upper and lower surface of the insulating layer 230 may include a conductive metal such as copper (Cu), nickel (Ni), gold (Au), or the like, and may be formed by forming a thin layer by the PVD method, or the like, followed by etching. The first wiring layer 210 formed on the upper surface of the insulating layer 230 forms an internal electrode having a cathode portion 210a and an anode portion 210b, spaced apart from each other, and the second wiring layer 220 formed on the lower surface of the insulating layer 230 forms an external electrode having a cathode portion 220a and an anode portion 220b, spaced apart from each other. Thickness of the first and second wiring layers 210 and 220 may be 4 μm to 10 μm.

The substrate 200 may include an internal electrode first wiring layer 210 on the upper surface of the insulating layer 230 formed by penetrating the insulating layer 230, an external electrode second wiring layer 220 on a lower surface and a plurality of via electrodes 240 connecting the first and second wiring layers 210 and 220. The plurality of via electrodes 240 may include a first via electrode connecting the anode portions 210b and 220b of the first and second wiring layers 210 and 220 to each other, and a second via electrode connecting the cathode portions 210a and 220a of the first and second wiring layers 210 and 220 to each other.

Referring to FIGS. 2A and 2B, first and second wiring layers 210 and 220 are integrally formed with a via electrode 240 to be in contact therewith. In this regard, referring to FIG. 3, an interface may not be formed between the first and second wiring layers 210 and 220.

The via electrode 240 may be formed by forming a hole inside the insulating layer 230 using a punching process or a laser drilling process. In the present exemplary embodiment, the via electrode 240 and the wiring layers 210 and 220o may be formed in the hole by plating-filling. In this regard, the internal electrode first wiring layer 210 and the external electrode second wiring layer 220 may be electrically connected to each other by plating. Further, a body 100 of a cathodic portion is directly connected to the second wiring layer 220 through the via electrode 240 by the internal electrode first wiring layer 210 on the insulating layer 230. A conventional capacitor structure, in which an external electrode, such as a lead frame structure, or the like, is disposed on a side surface, has problems in that resistance may increase due to a reduced contact surface area of the external and internal electrodes and detachment of the external electrode from the internal electrode. In the present exemplary embodiment, the internal electrode first wiring layer 210 and the external electrode second wiring layer 220 are integrally formed on the insulating layer 230. As a result, a contact surface area between the external and internal electrodes increases, thereby reducing resistance. As another exemplary, the via electrode 240 may be manufactured by filling a conductive material such as Cu, Ag, or the like. A diameter of the via electrode 240 may be 50 μm to 200 μm.

The via electrode 240 has one surface in contact with the first wiring layer 210 and the other surface in contact with the second wiring layer 220. Aline width L1 of the one surface of the via electrode 240 and a line width L2 of the other surface may be larger than a line width Lc of a central portion of the via electrode 240. As previously described, the via electrode 240 may be formed by forming an internal hole inside the insulating layer 230 by a laser process. By controlling strength of a laser, the line widths L1, L2 of the one and other surfaces of the via electrode 240 can be larger than the line width Lc of the central portion of the via electrode 240, thereby securing electric connection between the first and second wiring layers 210 and 220.

The body 100 of the cathodic portion may be coupled and electrically connected to the internal electrode first wiring layer 210 on the upper surface of the insulating layer 230 by the coupling portion 500.

The coupling portion 500 may include a conductive paste having viscosity, such as Ag, Au, Pd, Ni, Cu, or the like, and may be formed by applying to a portion of a lower surface of the body 100 of the cathodic portion and curing the same at a temperature of 30° C. to 300° C.

Referring to FIGS. 2A and 2B, a tantalum wire 110 of an anodic portion is connected to the first and second wiring layers 210 and 220 of the substrate 200. According to FIG. 2B, as another embodiment of the present disclosure, the tantalum wire 110 of a solid electrolytic capacitor 2000 may be disposed in a portion lower than the central portion of the body 100 to enhance binding force and decreasing surface resistance.

Meanwhile, referring to FIGS. 2A and 2B, the tantalum wire 110 may be directly connected to the internal electrode first wiring layer 210 formed on the upper surface of the insulating layer by a connection portion 300.

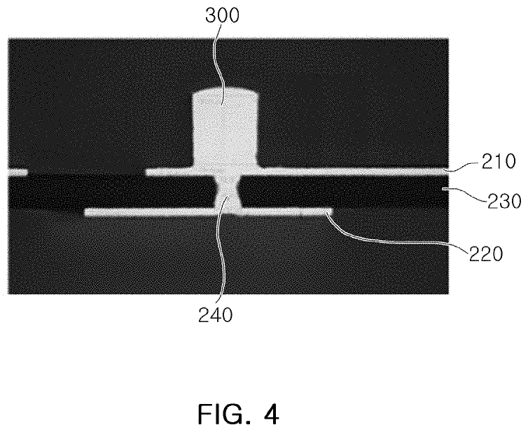

Referring to FIGS. 2A and 2B, the first and second wiring layers 210 and 220, integrally formed with the connection portion 300, is in contact with the connection portion 300. In this regard, referring to FIG. 4, an interface between the first and second wiring layers 210 and 220 and the connection portion 300 may not be formed.

In the present exemplary embodiment, the connection portion 300 and the first and second wiring layers 210 and 220 may be formed on upper and lower surfaces of the substrate by plating. In this regard, the first and second wiring layers 210 and 220 and the connection portion 300 may be electrically connected to each other by plating. Further, the body 100 of the anodic portion may be directly connected to the first wiring layer 210 by the connection portion 300 on the insulating layer 230 so as to be connected to the second wiring layer through the via electrode 240.

A conventional capacitor structure in which a cathodic portion of a body 100 is connected to an external electrode may have a relatively small contact surface area between the external electrode and a tantalum wire. In this regard, resistance increases on the contact surface and detachment occurs between the external electrode and the tantalum wire. In the present exemplary embodiment, the first and second wiring layers 210 and 220 and the connection portion 300 are integrally formed on the insulating layer 230. As a result, a contact surface area between the external electrode and the tantalum wire increases, thereby reducing resistance. That is, the anodic portion and the external electrode are connected through the connection portion 300 having a partitioning wall shape to enhance bonding stability. Further, a mounting surface may be minimized by directly connecting the tantalum wire to the external electrode second wiring layer 220 disposed on a lower portion of the body 100, as compared to a conventional structure in which an electrode is formed on a side surface of the body 100.

Further, a structure in which all electrodes conduct only internally is feasible by electrically coupling the tantalum wire 110 to the internal electrode first wiring layer 210 and relatively lower ESR can be implemented. That is, as formation of a side surface electrode is unnecessary, processes can be simplified.

The first and second wiring layers 210 and 220, the via electrode 240 and the connection portion 300 may include a seed layer 250 and at least one plating layer 260 formed on the seed layer 250.

As an example, when the first and second wiring layers 210 and 220, the via electrode 240 and the connection portion 300 are formed on the one surface of the insulating layer 230 by plating, the first and second wiring layers 210 and 220, the via electrode 240 and the connection portion 300 may include a electrolytic plating layer 260 and the seed layer 250, such as an electroless plating layer, or the like. In this case, the electrolytic plating layer 260 may have a single layer structure or a multilayer structure. A multilayer electrolytic layer may be formed to have a conformal film structure covering any one electrolytic plating layer by another electrolytic plating layer or a form in which one electrolytic plating layer is only stacked on one surface of another electrolytic plating layer. The seed layer 250 of the first and second wiring layers 210 and 220, that of the via electrode 240 and that of the connection portion 300 are integrally formed and may thus not have an interface therebetween, but are not limited thereto. The electrolytic plating layer 260 of the first and second wiring layers 210 and 220 and those of the via electrode 240 and the connection portion 300 are integrally formed and may thus not have an interface formed therebetween, but are not limited thereto.

The first and second wiring layers 210 and 220, the via electrode 240 and the connection portion 300 may include a conductive material such as Cu, Al, Ag, Sn, Au, Ni, Pb, Ti or alloys thereof, but are not limited thereto.

According to an exemplary embodiment of the present disclosure, a solid electrolytic capacitor has a structure in which an internal lead frame is not formed, such that capacitance is improved and ESR is reduced.

In one exemplary embodiment, the first and second wiring layers do not extend onto side surfaces of the solid electrolytic capacitor.

In addition, a solid electrolytic capacitor may have increased mounting surface area by forming a via electrode using a pattern-formed substrate and forming an anode connection portion using a plating method.

While exemplary embodiments have been illustrated and described above, it will be apparent to those skilled in the art that modifications and deviations could be made without departing from the scope of the present disclosure as defined by the appended claims.

What is claimed is:

1. A solid electrolytic capacitor, comprising:
a body comprising a tantalum wire disposed on one end thereof;
a substrate, on which the body is disposed, comprising an insulating layer, first and second wiring layers respectively disposed on a first surface and a second surface, facing each other, of the insulating layer, and a via electrode penetrating the insulating layer to connect the first and second wiring layers to each other; and
a connection portion connecting the tantalum wire to the first wiring layer,
wherein the first and second wiring layers and the via electrode are integrally formed.

2. The solid electrolytic capacitor of claim 1, wherein an interface is not formed between the first and second wiring layers and the via electrode.

3. The solid electrolytic capacitor of claim 1, wherein the first and second wiring layers and the connection portion are integrally formed.

4. The solid electrolytic capacitor of claim 3, wherein an interface is not formed between the first and second wiring layers and the connection portion.

5. The solid electrolytic capacitor of claim 1, wherein the first and second wiring layers, the connection portion and the via electrode each comprise a seed layer and a plating layer disposed on the seed layer.

6. The solid electrolytic capacitor of claim 1, wherein the via electrode is formed in plural.

7. The solid electrolytic capacitor of claim 1, wherein the via electrode comprises a third surface in contact with the first wiring layer and a fourth surface in contact with the second wiring layer, and
a line width of the third surface and a line width of the fourth surface of the via electrode are larger than a line width of a central portion of the via electrode.

8. The solid electrolytic capacitor of claim 1, wherein the tantalum wire is disposed in a portion lower than a central portion of the body.

9. The solid electrolytic capacitor of claim 1, further comprising a molding portion surrounding the body and the tantalum wire.

10. The solid electrolytic capacitor of claim 1, further comprising a coupling portion arranged between the body and the first wiring layer.

11. The solid electrolytic capacitor of claim 10, wherein the coupling portion comprises one or more selected from the group consisting of silver (Ag), gold (Au), lead (Pd), nickel (Ni) and copper (Cu).

12. A solid electrolytic capacitor, comprising:
a body comprising a tantalum wire disposed on one end thereof;
a substrate, on which the body is disposed, comprising:
an insulating layer;
first and second wiring layers disposed on first and second surfaces, opposing each other, of the insulating layer, each of the first and second wiring layers having an anode portion and a cathode portion;
first and second via electrodes penetrating the insulating layer to connect the anode portions of the first and second wiring layers to each other and connect the cathode portions of the first and second wiring layers to each other, respectively; and
a connection portion connecting the tantalum wire to the anode portion of the first wiring layer.

13. The solid electrolytic capacitor of claim 12, wherein the anode and cathode portions of the first wiring layer are spaced apart from each other, and the anode and cathode portions of the second wiring layer are spaced apart from each other.

14. The solid electrolytic capacitor of claim 12, wherein the anode portions of the first and second wiring layers and the first via electrode are integrally formed, and
the cathode portions of the first and second wiring layers and the second via electrode are integrally formed.

15. The solid electrolytic capacitor of claim 12, wherein the anode portions of the first and second wiring layers and the connection portion are integrally formed.

16. The solid electrolytic capacitor of claim 12, wherein the first and second wiring layers, the connection portion, and the first and second via electrodes each comprise a seed layer and a plating layer formed disposed on the seed layer.

17. A solid electrolytic capacitor, comprising:
a body comprising a tantalum wire disposed on one end thereof in a length direction of the body;
a substrate disposed below the body in a thickness direction of the body, perpendicular to the length direction, and comprising an insulating layer, first and second wiring layers respectively disposed on a first surface and a second surface, facing each other, of the insulating layer, and a via electrode penetrating the insulating layer to connect the first and second wiring layers to each other; and
a connection portion connecting the tantalum wire to the first wiring layer,
wherein the first and second wiring layers do not extend onto side surfaces of the solid electrolytic capacitor, the side surfaces being defined in the length direction.

18. The solid electrolytic capacitor of claim 17, wherein the first and second wiring layers, the via electrode, and the connection portion are integrally formed.

19. The solid electrolytic capacitor of claim 17, wherein an interface is not formed between the first and second wiring layers and the via electrode.

20. The solid electrolytic capacitor of claim 17, wherein an interface is not formed between the first and second wiring layers and the connection portion.
